(19) United States
(12) Patent Application Publication
(10) Pub. No.: US 2023/0206057 A1
(43) Pub. Date: Jun. 29, 2023

(54) NEURAL NETWORK WITH FIXED CLASSIFICATION MATRIX

(71) Applicant: International Business Machines Corporation, Armonk, NY (US)

(72) Inventors: Michael Andreas Hersche, Zurich (CH); Kumudu Geethan Karunaratne, Gattikon (CH); Giovanni Cherubini, Rueschilkon (CH); Abu Sebastian, Adliswil (CH); Abbas Rahimi, Zurich (CH)

(21) Appl. No.: 17/564,279

(22) Filed: Dec. 29, 2021

(51) Int. Cl. G06N 3/08; G06N 3/04; G06K 9/62

(52) U.S. Cl. CPC G06N 3/08; G06N 3/04; G06K 9/6239; G06K 9/6251

(57) ABSTRACT

A computer-implemented method for performing a classification of an input signal by a neural network includes: computing, by a feature extraction unit of the neural network, a D-dimensional query vector, wherein D is an integer; generating, by a classification unit of the neural network, a set of C fixed D-dimensional quasi-orthogonal bipolar vectors as a fixed classification matrix, wherein C is an integer corresponding to a number of classes of the classification unit; and performing a classification of a query vector based, at least in part, on the fixed classification matrix.

### BACKGROUND

The present invention relates to the field of neural networks, and more specifically, to a neural network including a feature extraction unit and a classification unit.

Neural networks are commonly used as models for classification for a wide variety of tasks. Typically, a learned affine transformation is placed at the end of such models, yielding a per-class value used for classification. This classifier can have a vast number of parameters, which grows linearly with the number of possible classes, thus requiring increasingly more resources for storage and computations.

### SUMMARY

According to one embodiment of the present invention, a computer-implemented method for performing a classification of an input signal by a neural network is disclosed. The computer-implemented method includes computing, by a feature extraction unit of the neural network, a D-dimensional query vector, where D is an integer. The computer-implemented method further includes generating, by a classification unit of the neural network, a set of C fixed D-dimensional quasi-orthogonal bipolar vectors as a fixed classification matrix, where C is an integer corresponding to a number of classes of the classification unit. The computer-implemented method further includes performing a classification of a query vector based, at least in part, on the fixed classification matrix.

According to another embodiment of the present invention, a computer program product for performing a classification of an input signal by a neural network is disclosed. The computer program product includes one or more computer readable storage media and program instructions stored on the one or more computer readable storage media. The program instructions include instructions to compute, by a feature extraction unit of the neural network, a D-dimensional query vector, where D is an integer. The program instructions further include instructions to generate, by a classification unit of the neural network, a set of C fixed D-dimensional quasi-orthogonal bipolar vectors as a fixed classification matrix, where C is an integer corresponding to a number of classes of the classification unit. The program instructions further include instructions to perform a classification of a query vector based, at least in part, on the fixed classification matrix.

According to another embodiment of the present invention, a computer system for performing a classification of an input signal by a neural network is disclosed. The computer system includes one or more computer system includes one or more computer processors, one or more computer readable storage media, and program instructions stored on the computer readable storage media for execution by at least one of the one or more processors. The program instructions include instructions to compute, by a feature extraction unit of the neural network, a D-dimensional query vector, where D is an integer. The program instructions further include instructions to generate, by a classification unit of the neural network, a set of C fixed D-dimensional quasi-orthogonal bipolar vectors as a fixed classification matrix, where C is an integer corresponding to a number of classes of the classification unit. The program instructions further include instructions to perform a classification of a query vector based, at least in part, on the fixed classification matrix.

### BRIEF DESCRIPTION OF THE SEVERAL VIEWS OF THE DRAWINGS

FIG. 1 is a simplified schematic block diagram of a neural network, generally designated 100, in accordance with at least one embodiment of the present invention, according to an embodiment of the invention.

FIG. 2 illustrates an implementation of a fixed classification matrix W, generally designated 200, in accordance with at least one embodiment of the present invention.

FIG. 3 is a flow chart of a method for performing a classification of a query vector, generally designated 300, in accordance with at least one embodiment of the present invention.

FIG. 4 illustrates an implementation of the fixed classification matrix W presented as a search tree, generally designated 400, in accordance with at least one embodiment of the present invention.

FIG. 5 illustrates an implementation of the fixed classification matrix W presented as a D-dimensional cellular automaton, generally designated 500, in accordance with at least one embodiment of the present invention.

FIG. 6 illustrates an implementation of the fixed classification matrix W presented in a resonator network, generally designated 600, in accordance with at least one embodiment of the present invention.

FIG. 7a illustrates a layer model of layers of a neural network, generally designated 700a, in accordance with at least one embodiment of the present invention.

FIG. 7b illustrates a layer model of layers of a neural network, generally designated 700b, in accordance with at least one embodiment of the present invention.

FIG. 8 illustrates a table, generally designated 800, listing the memory requirements, the complexity for rematerializing the fixed classification matrix, and the complexity to perform the classification in accordance with various embodiments of the present invention.

FIG. 9 illustrates a table, generally designated 900, listing the classification accuracy in accordance with various embodiments of the present invention.

FIG. 10 is a block diagram depicting components of an exemplary computing device, generally designated 1000, suitable for practicing various embodiments of the present invention.

FIG. 11 is a block diagram depicting a cloud computing environment 50 in accordance with at least one embodiment of the present invention.

FIG. 12 is a block diagram of a set of functional abstraction model layers provided by cloud computing environment 50 depicted in FIG. 7 in accordance with at least one embodiment of the present invention.

### DETAILED DESCRIPTION

The present invention relates to the field of neural networks, and more specifically, to a neural network including a feature extraction unit and a classification unit.

Fully-connected layers are still commonly used as classification layers in various neural network architectures, transforming from the dimension of network features D to the number of required class categories C. Therefore, each classification model must hold D×C number of trainable parameters that grows in a linear manner with the number of classes (i.e., C). Accordingly, there is a need for advantageous neural network architectures with reduced complexity.

High-dimensional (HD) computing is a brain-inspired non von Neumann machine learning model based on representing information with high-dimensional vectors. A processor based on HD computing may be seen as an extremely wide dataflow processor with a small instruction set of bit-level operations.

High-dimensional computing represents information by projecting data onto vectors in a high-dimensional space. HD vectors may be embodied by holographics and (pseudo)random with independent and identically distributed (i.i.d.) components. High-dimensional computing may also be denoted as hyperdimensional computing. High-dimensional vectors may also be denoted as hypervectors. According to embodiments of the present invention, the high-dimensional vectors/hypervectors may have dimensions of more than 100 elements, of more than 1,000 elements or of more than 10,000 elements.

Given a hypervector formed from an element-wise product of two or more atomic hypervectors (each from a fixed codebook), a resonator network may find its factors. The resonator network may iteratively search over the alternatives for each factor individually rather than all possible combinations until a set of factors is found that agrees with the input hypervector/query vector. The term “resonator network” as used herein may be defined in accordance with the following references: E. Paxon Frady et al. (“Resonator networks for factoring distributed representations of data structures,” Neural Computation 2020) and Spencer J. Kent et al. (“Resonator Networks outperform optimization methods at solving high-dimensional vector factorization,” Neural Computation 2020).

According to various embodiments of the present invention, a neural network comprising a feature extraction unit and a classification unit is provided. The neural network is configured to compute, by the feature extraction unit, a D-dimensional query vector, wherein D is an integer. The neural network is further configured to provide, by the classification unit, a set of C fixed D-dimensional quasi-orthogonal bipolar vectors as a fixed classification matrix, wherein C is an integer corresponding to a number of classes of the classification unit. The neural network is further configured to use the fixed classification matrix for performing a classification of the query vector. The term “quasi-orthogonal vectors as used herein shall be understood as vectors that are orthogonal to each other with a predefined probability which increases with growing dimension D. The predefined probability may have a discrete binomial distribution, which can be approximated by a normal distribution with standard deviation that scales with factor (1/(\sqrt{D}).

Such an embodied neural network architecture provides reduced complexity as compared to a fully connected layer. In particular, it provides advantages in terms of simplified storage and computation. Furthermore, such an embodied neural network architecture may support an arbitrary number of classes, and in particular, the number of classes C may be different from the dimension D of the query vector.

In an embodiment, the neural network is configured to compute, by the classification unit, the set of C fixed D-dimensional quasi-orthogonal bipolar vectors from a D-dimensional random bipolar seed vector. This provides particular advantages in terms of storage requirements. More particularly, only the seed vector has to be stored. The memory requirements are only in the order of D of the D-dimensional bipolar vector. The seed vector is random in the sense that it comprises independent and equally distributed components.

In an embodiment, the neural network is configured to compute, by the classification unit, the set of C fixed D-dimensional quasi-orthogonal bipolar vectors by randomly permuting the seed vector a predefined number of times, e.g. (C-1) times. This is an efficient method to rematerialize the fixed classification matrix from the seed vector.

In an embodiment, the neural network is configured to store the seed vector in an item memory. The neural network is further configured to perform a first similarity computation between the seed vector and the query vector to obtain a first class score. The neural network is further configured to perform a plurality of times, in particular (C-1) times, a permutation step to compute a predefined permutation of the seed vector, thereby computing a respective permuted seed vector. In addition, the neural network is configured to perform, after each permutation step, a further similarity computation between the respective permuted seed vector and the query vector to obtain a further class score.

Such an embodiment is very memory-efficient. More particularly, the memory requirements to store the D-dimensional seed vector are in the order of D. The permutation and the subsequent similarity computation are performed sequentially, and the similarity computation requires order of C computations to finish the respective classification task. The similarity computation may be embodied as a dot product computation. The similarity computation may also be denoted as a distance computation.

In an embodiment, the neural network is configured to provide a D-dimensional cellular automaton. According to such an embodiment, the neural network is configured to initialize the D-dimensional cellular automaton with the seed vector. The neural network is further configured to perform a first similarity computation between the seed vector and the query vector to obtain a first class score and to perform a plurality of times, in particular (C-1) times, a permutation step to compute a predefined permutation of the seed vector, thereby computing a respective permuted seed vector. The permutation step includes applying a transformation rule to the seed vector. In an embodiment, the transformation rule is Rule 30.

The neural network is further configured to perform, after each permutation step, a further similarity computation between the respective permuted seed vector and the query vector to obtain a further class score.

Such an embodiment is also very memory-efficient. More particularly, the memory requirements to store the D-dimensional seed vector are in the order of D. The similarity computation, which may be a dot product computation, requires an order of C computations to finish the respective classification task.

Compared to the above embodiment of permuting a seed vector of an item memory, this cellular automaton-based method is particularly useful when C>D because the number of “cheap” permutations (as one-bit circular shift operation) is limited to D, while the cellular automaton can generate D-bit quasi-orthogonal vectors when C>D.

In an embodiment, the neural network is configured to provide a search tree. The search tree comprises C leaf nodes, in which the C leaf nodes are configured to store the C fixed D-dimensional quasi-orthogonal bipolar vectors. In an embodiment, the neural network is additionally configured to store intermediate nodes and a root node by bundling the quasi-orthogonal bipolar vectors from the nodes which are connected to the intermediate or root node. In an embodiment, the neural network is further configured to perform the similarity computation between the query vector and the C fixed D-dimensional quasi-orthogonal bipolar vectors by choosing the tree path in the search tree which has the highest similarity with the query vector.

While such an embodiment requires more memory compared with other embodiments as presented above, it is computationally more efficient. More particularly, such an embodiment costs O(D×2^{log}^{_{C}}) for the memory to store all the vectors including the intermediate vectors, but instead performs the search computation much faster in O(log C).

In an embodiment, the neural network includes a resonator network. The resonator network is configured to provide a plurality of codebooks, wherein each codebook of the plurality of codebooks includes a set of codebook vectors. A set of combinations of the vector products of the codebook vectors of the plurality of codebooks establishes the number of classes of the classification unit. The neural network is configured to perform, by the resonator network, a factorization of the query vector to the codebook vectors of the plurality of codebooks to determine a corresponding class of the number of classes.

Hence, according to such an embodiment, the fixed classification matrix is provided by a resonator network with a fixed number of codebooks. Such a classification by means of a resonator network is a very efficient method, and particularly useful for classification tasks having a high number (i.e., above a predetermined threshold) of classes.

In an embodiment, the neural network is configured to perform a training phase of the feature extraction unit. The training phase is configured to train the neural network. As the classification matrix is fixed, it remains unchanged during the training phase. Rather, only the feature extraction unit is changed/trained during the training phase.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

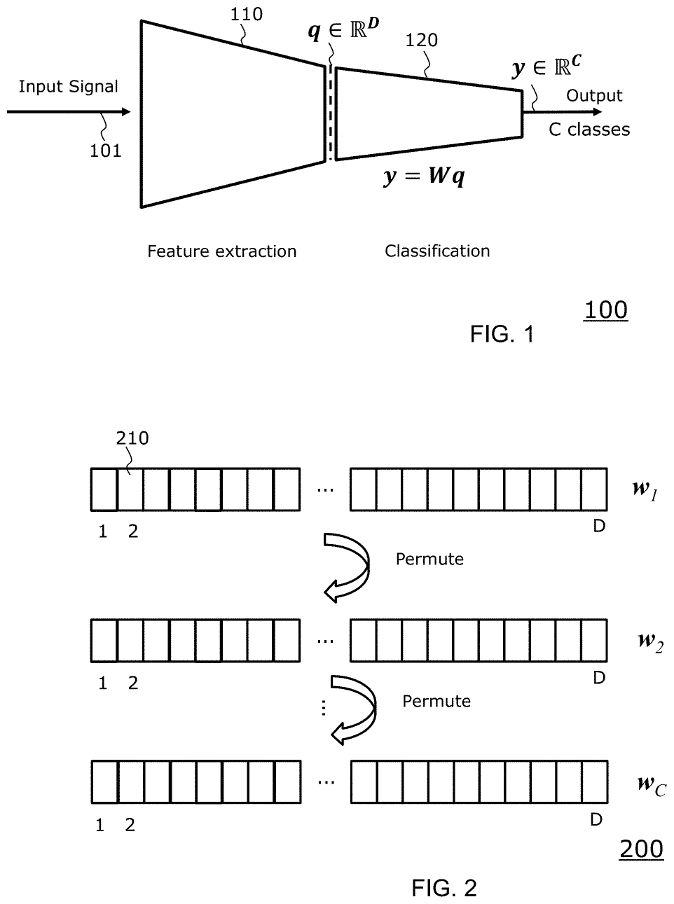

The present invention will now be described in detail with reference to the Figures. FIG. 1 is a simplified schematic block diagram of a neural network, generally designated 100, in accordance with at least one embodiment of the present invention. The neural network 100 includes a feature extraction unit 110 and a classification unit 120. The feature extraction unit 110 is configured to receive an input signal 101 (e.g. a digital image). The feature extraction unit 110 is further configured to extract a query vector q from the input signal 110, more particularly to compute a D-dimensional query vector from an input signal 101, wherein D is an integer. The query vector may be in particular a vector q∈ [symbol] . The feature extraction unit 110 may be generally defined as a unit which maps the input signal 101 to a query vector, wherein the query vector describes the input signal 101 with a reduced number of resources. For this, the feature extraction unit 110 may include one or more convolutional layers which perform an abstraction of the input signal 101. The one or more convolutional layers convolve the respective input signal 101 and pass its result to the next layer. The computed query vector is then passed to the classification unit 120. The classification unit 120 is configured to provide a fixed classification matrix W, (i.e., a classification matrix which has elements that are not going to be trained during a training phase of the neural network 100, but rather stay fixed during the training phase). In an embodiment, the fixed classification matrix W may be built from random codes and implemented in various ways.

The classification unit 120 is further configured to map a respective query vector q to a corresponding class of a number of classes C, wherein C is an integer. More particularly, the fixed classification matrix is used for performing a classification of the query vector (i.e., to assign the query vector to one class of the number of classes which has the closest similarity to the query vector). For this, the classification unit 120 may perform a matrix vector multiplication of the fixed classification matrix W with the vector q, more particularly y=Wq, wherein y∈ [symbol] . In an embodiment, the fixed classification matrix may be formed by a set of C fixed D-dimensional and quasi-orthogonal bipolar vectors, which ultimately form a fixed quasi-orthogonal matrix.

In an embodiment, the D-dimensional and quasi-orthogonal bipolar vectors form a D-dimensional vector space. In general, each of the D-dimensional and quasi-orthogonal vectors include D numbers that define the coordinates of a point in the vector space. In an embodiment, the D-dimensional vectors are in {−1, +1}^{D} and are hence referred to as “bipolar.”

FIG. 2 illustrates an implementation of the fixed classification matrix W according to a first embodiment. According to such an embodiment, the neural network comprises an unfolded item memory, generally designated 200. The unfolded item memory 200 is configured to store a seed vector w₁. The seed vector w₁ may be embodied as D-dimensional or D-bit random bipolar seed vector. Accordingly, the unfolded item memory 200 comprises D-fields 210 for storing the D-bits. The D-bit seed vector may be initialized from a binomial distribution with p=0.5 and n=D.

The classification unit 120 may compute the set of C fixed D-dimensional quasi-orthogonal bipolar vectors from the D-dimensional random bipolar seed vector w₁. This may be done by randomly permuting the seed vector a predefined number of times, and in particular, (C-1) times. In an embodiment, the random permutation may be a cyclic shift operation, in which each of the cyclic shift operations produces a new quasi-orthogonal bipolar vector of the classification matrix. More particularly, after a first permutation, a permuted vector w₂ has been produced, after a second permutation, a permuted vector w₃, and so on, until a (C-1)-th permutation has produced a permuted vector w_{C}. The set of vectors w₁, w₂, . . . w_{C} form together the classification matrix W.

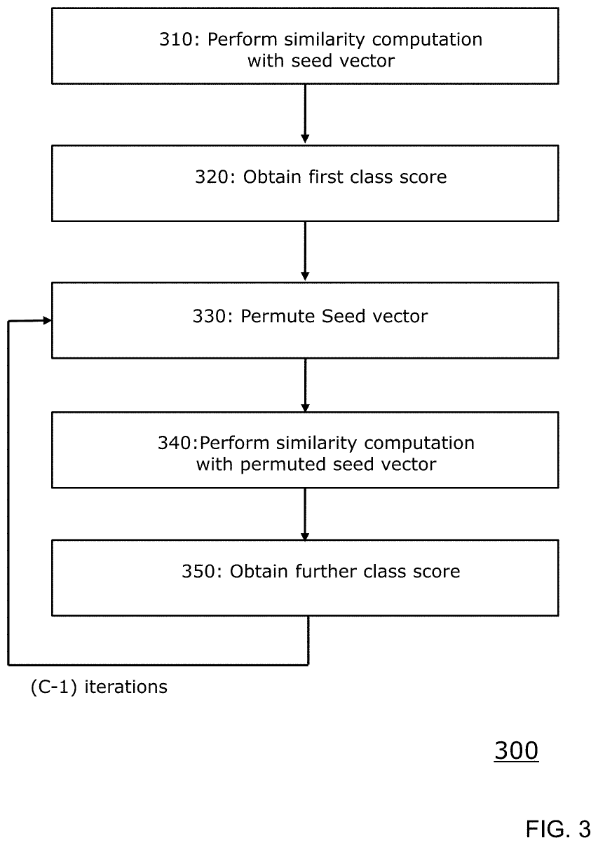

In an embodiment, the classification of the query vector may be then performed as illustrated with reference to the flow chart 300 as shown in FIG. 3, in accordance with at least one embodiment of the present invention. At step 310, a first similarity computation between the original seed vector w₁ and the current query vector q is performed. This results in a first class score. In an embodiment, the similarity computation may also be denoted as a distance computation. The similarity computation may be performed in particular as a dot product computation.

At step 320, a first class score is obtained. At step 330, the original seed vector is permuted, resulting in a permuted seed vector w₂. At step 340, a further similarity computation is performed between the permuted seed vector w₂ and the query vector q. At step 350, a second class score is obtained as a further class score. Steps 330-350 are repeated (e.g. (C-1) iterations). As a result, C class scores are computed. The highest value of the class score is then output as the related class to the query vector q. Since the computation of the class score is done sequentially, it costs only O(D) in memory to store the vector state and O(C) similarity/dot product computations to finish the classification task.

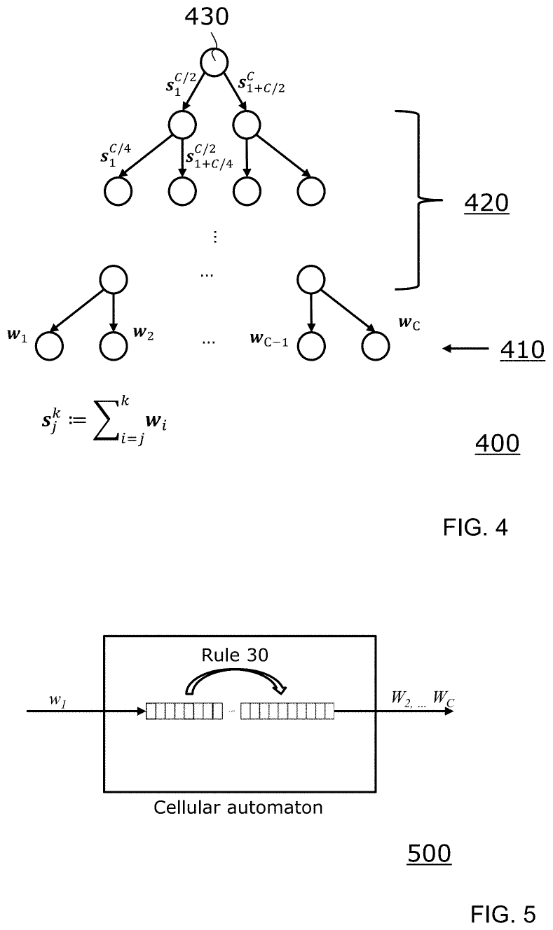

FIG. 4 illustrates an implementation of the fixed classification matrix W presented as a search tree, generally designated 400, in accordance with at least one embodiment of the present invention. As depicted in FIG. 4, the search tree 400 is a binary search tree. However, in other embodiments of the present invention, the search tree 400 can be any type of search tree (e.g., a ternary search tree).

The search tree 400 comprises C leaf nodes 410 representing the C classes 1 to C, assuming C is a power of 2. The C-leaf nodes correspond to the C fixed D-dimensional quasi-orthogonal bipolar vectors w₁, w₂, . . . , w_{C} which form together the classification matrix W.

The search tree 400 is configured to store intermediate nodes 420 and a root node 430 by bundling the quasi-orthogonal bipolar vectors w₁, w₂, . . . , w_{C} from the nodes which are connected to the intermediate nodes 420 or the root node 430. More particularly, the intermediate nodes are computed by performing a component-wise addition of the vectors of the connected nodes. This has formed a search tree of height log C. Once the search tree 400 has been formed, the classification may be performed in an inference phase by choosing the path within the search tree 400 that leads to the highest similarity/dot product with the query vector q.

In an embodiment, the similarity computation is performed between the query vector q and the C fixed D-dimensional quasi-orthogonal bipolar vectors w₁, w₂, . . . , w_{C} by choosing the tree path having the highest similarity with the query vector. This costs O(D×2^{log}^{_{C}}) for memory to store all intermediate vectors, but instead performs the search computation much faster in O(log C). The summation (component-wise addition) may be performed as follows:

sⱼ^{k}:=Σᵢ₌ⱼ^{k}wᵢ; equation 1

FIG. 5 shows an implementation of the fixed classification matrix W presented as a D-dimensional cellular automaton, generally designated 500, in accordance with at least one embodiment of the present invention. The cellular automaton 500 is initialized with the seed vector w₁. The corresponding neural network is configured to perform a first similarity computation between the seed vector and the query vector to obtain a first class score. The cellular automaton 500 is configured to perform subsequently (e.g., C-1 times) a permutation step to compute a predefined permutation of the seed vector w₁ thereby computing a respective permuted seed vector. In an embodiment, the cellular automaton 500 may apply Rule 30 as a transformation rule/transformation function.

The neural network is further configured to perform, after each permutation step, an additional similarity computation between the respective permuted seed vector and the query vector to obtain an additional class score.

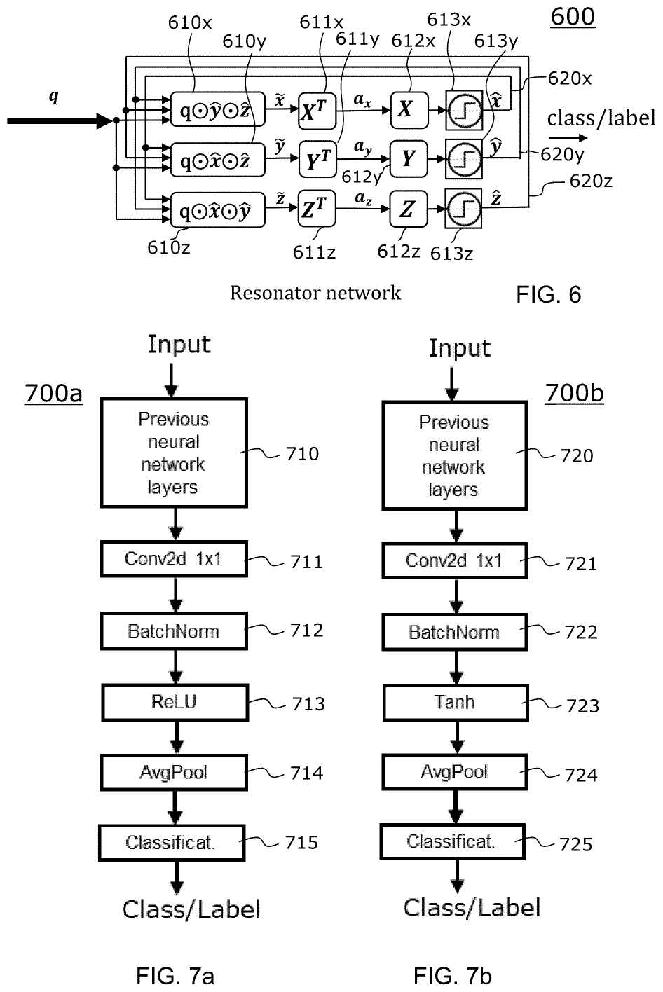

FIG. 6 illustrates an implementation of the fixed classification matrix W presented in a resonator network, generally designated 600, in accordance with at least one embodiment of the present invention. More particularly, a neural network is provided, in which the neural network includes the resonator network 600 as the classification unit. Accordingly, the resonator network 600 is configured to perform a factorization of the fixed classification matrix W For example, the classification unit 120 of FIG. 1 may be implemented by the resonator network 600 as shown in FIG. 6. According to such an embodiment, the random quasi-orthogonal bipolar matrix W may be built from F codebooks in the resonator network 600. The resonator network 600 may generally be configured to provide a plurality of F codebooks.

With reference to FIG. 6, the resonator network 600 includes F=3 codebooks X, Y and Z. The codebook X comprises m codebook vectors x₁ . . . xₘ. The codebook Y comprises m codebook vectors y₁ . . . yₘ. The codebook Z comprises m code book vectors z₁ . . . zₘ. The transpose W^{T} of the classification matrix may be represented as W^{T}={w₁, w₂, . . . , w_{C}}.

The corresponding elements of W^{T} may then be represented as follows:

$$\begin{matrix}{w}_{1} = {x}_{1} ⊙ {y}_{1} ⊙ {z}_{1} \\ {w}_{2} = {x}_{2} ⊙ {y}_{1} ⊙ {z}_{1} \\ ⋮ \\ {w}_{C} = {x}_{m} ⊙ {y}_{m} ⊙ {z}_{m}\end{matrix}$$

The resonator network 600 includes three network nodes: 610x, 610y and 610z. The three network nodes 610x, 610y and 610z are configured to perform an elementwise multiplication ⊙ of three input signals including the query vector q. The resonator network 600 further includes memories 611x, 611y and 611z for storing the transposes of the codebooks X^{T}, Y^{T} and Z^{T}, respectively. The resonator network 600 further includes memories 612x, 612y and 612z for storing the codebooks X, Y and Z, respectively. The resonator network 600 further includes non-linear units 613x, 613y and 613z, which are configured to perform a non-linear operation (e.g., the sign function). The resonator network 600 further includes three processing lines: 620x, 620y and 620z, wherein each processing line provides an estimate of a codebook vector for the factorization of the respective query vector q. More particularly, the processing line 620x provides estimates \hat{x}, the processing line 620y provides estimates ŷ and the processing line 620z provides estimates \hat{z}.

During an inference phase of the neural network 100, the neural network 100 receives the input signal 101 (e.g. an image), and the feature extraction unit 110 computes a corresponding query vector q. The feature extraction unit 110 provides this query vector q, as input signal, to the resonator network 600 for performing a classification. The factorization of the query vector q to the codebook vectors can then be performed as follows. At an initial iteration i=0, the resonator network 600 initializes an estimate of the codebook vectors that factorize the query vector (e.g. an estimate representing a superposition of all candidate codebook vectors) as follows:

$$\hat{x} ( 0 ) = sign ( {\sum }_{h = 1 , … , m} {x}_{h} ) ;$$

$$\hat{y} ( 0 ) = sign ( {\sum }_{j = 1 , … , m} {y}_{j} ) ; and$$

$$\hat{z} ( 0 ) = sign ( {\sum }_{k = 1 , … , m} {z}_{k} ) .$$

The computations of the resonator network 600 may then be described for a current iteration i as follows: The network nodes 610x, 610y and 610z receive simultaneously or substantially simultaneously the respective triplet (q, ŷ(i), \hat{z}(i)), (q, \hat{x}(i), \hat{z}(i)) and (q, \hat{x}(i), ŷ(i)). The network nodes compute the first estimates \tilde{z}(i), \tilde{y}(i) and \tilde{z}(i) of the codebook vectors that represent the factorization of the query vector as follows:

\tilde{x}(i)=q⊙ŷ(i)⊙\hat{z}(i);

\tilde{y}(i)=q⊙\hat{x}(i)⊙\hat{z}(i);

\tilde{z}(i)=q⊙\hat{x}(i)⊙ŷ(i),

where ⊙ refers to an elementwise multiplication. This may be referred to as an inference step. In other words, the nodes perform the inference step on the respective input triplets.

The similarity of the first estimate \tilde{x}(i) with each of the m codebook vectors x₁ . . . xₘ is computed using the transpose codebook X^{T} stored in memory 611x as follows: aₓ(i)=X^{T}\tilde{x}(i)∈ [symbol] . Here, the hypervector \tilde{x}(i) is multiplied by the transpose codebook X^{T}. The similarity of the first estimate \tilde{y}(i) with each of the m code hypervectors y₁ . . . yₘ is computed using the transpose codebook Y^{T} stored in memory 611y as follows: a_{y}(i)=Y^{T} \tilde{y}(i)∈ [symbol] for multiplying the hypervector \tilde{y}(i) by the matrix Y^{T}. The similarity of the first estimate \tilde{z}(i) with each of m codebook vectors z₁ . . . zₘ is computed using the transpose codebook Z^{T} stored in memory 611z as follows: a_{z}(i)=Z^{T} \tilde{z}(i)∈ [symbol] for multiplying the hypervector \tilde{z}(i) by the matrix Z^{T}. The resulting vectors aₓ(i), a_{y}(i) and a_{z}(i) may be denoted as similarity vectors. The largest element of each of the similarity vectors aₓ(i), a_{y}(i) and a_{z}(i) indicates the codebook vector which matches best the first estimate \tilde{x}(i), \tilde{y}(i) and \tilde{z}(i) respectively.

After obtaining the similarity vectors aₓ(i), a_{y}(i) and a_{z}(i), a weighted superposition of the similarity vectors aₓ(i), a_{y}(i) and a_{z}(i) is performed using the codebooks X, Y and Z stored in memories 612x, 612y, and 612z, respectively. This may be performed by the following matrix vector multiplications: Xaₓ(i), Ya_{y}(i) and Za_{z}(i). The resulting vectors Xaₓ(i), Ya_{y}(i) and Za_{z}(i) are forwarded to the sign units 613x, 613y and 613z, respectively. As a result, an output of the sign units may be computed as follows:

\hat{x}(i+1)=sign(Xaₓ(i));

ŷ(i+1)=sign(Ya_{y}(i)); and

\hat{z}(i+1)=sign(Za_{z}(i)), respectively.

Accordingly, new estimates of the hypervectors \hat{x}(i+1), ŷ(i+1) and \hat{z}(i+1) have been computed for the next iteration i+1. The iterative process may stop if a conversion criterion or a stopping criterion is fulfilled. In an embodiment, the conversion criterion may require that \hat{x}(i+1)=\hat{x}(i), ŷ(i+1)=ŷ(i) and \hat{z}(i+1)=\hat{z}(i). In other words, the iterative algorithms have converged, and the estimates no longer change. In an embodiment, the stopping criterion may require that a maximum number of iterations (e.g., 1000 iterations) have been reached.

In an embodiment, the resonator network 600 may perform the unbinding operations in parallel for all the codebooks (i.e. codebooks X, Y and Z), which leads to higher accuracy. In other words, the resonator network 600 performs a parallel execution/computation of the F factors. During inferencing, the resonator network 600, with parallel execution of F factors, costs

$$O ( D \times F \times \sqrt[F]{C} )$$

in memory and O(α) in computation, where α˜0.001×C when C is large (above a predetermined threshold).

FIG. 7a illustrates a layer model of layers of a neural network, generally designated 700a, in accordance with at least one embodiment of the present invention. As depicted in FIG. 7a, an input, such as an image, is provided to one or more neural network layers 710. The output of a previous neural network layer is provided to a convolutional layer 711, which may be embodied, for example, as a D-convolutional layer.

The output of the convolutional layer 711 is processed by a batch-normalization layer 712 which is configured to perform a batch normalization process. The output of the batch-normalization layer 712 is fed to an activation layer 713. The activation layer 713 is configured to apply an activation function. The activation layer 713 of FIG. 7a is presented as a Rectifier Linear Unit (ReLU).

The output of the activation layer 713 is processed by an average pooling layer 714, which is configured to perform a pooling operation. The pooling operation may, for example, calculate an average value for portions of a feature map. The output of the average pooling layer establishes the query vector q for a classification layer 715. For example, the classification layer 715 corresponds to the classification unit 120 as shown in FIG. 1, and provides a set of C fixed D-dimensional quasi-orthogonal bipolar vectors as the fixed classification matrix W. The classification layer 715 is configured to perform a classification of the query vector q to one of the C-classes and to assign a corresponding class/label to the query vector q. In an embodiment, the convolutional layer 711, the batch-normalization layer 712, the activation layer 713, and the average pooling layer 714 correspond to the feature extraction unit 110 of FIG. 1.

FIG. 7b illustrates a layer model of layers of a neural network, generally designated 700b, in accordance with at least one embodiment of the present invention. The neural network according to FIG. 7b includes one or more neural network layers 720, a convolutional layer 721, a batch-normalization layer 722, an average pooling layer 724, and a classification layer 725. The one or more neural network layers 720, the convolutional layer 721, the batch-normalization layer 722, the average pooling layer 724, and the classification layer 725 may be embodied in the same manner as the neural network layers 710, the convolutional layer 711, the batch-normalization layer 712, the average pooling layer 714 and the classification layer 715 of FIG. 7a. However, the neural network according to FIG. 7b includes an activation layer 723 which is configured to apply an activation function presented as a Tan h (hyperbolic tangent) function. It should be appreciated that applying the Tan h-function as the activation function is advantageous in terms of accuracy when utilizing a fixed classification matrix with bipolar vectors.

As mentioned above, a neural network (e.g., the neural network 100 of FIG. 1) can be configured to perform a training phase, while the fixed classification matrix W remains constant/unchanged during the training. During the training phase, training data is fed into neural network 100, and a corresponding feedback loop aims at minimizing a loss function. The training phase, which may also be denoted as learning phase, adapts the parameters in the rest of neural network, i.e. apart from the fixed classification matrix, in order to increase the accuracy of the classification.

In an embodiment, loss functions with two hyperparameters (s,m) are proposed to guide the neural network for generating better quasi-orthogonal vectors. These two hyperparameters may effectively control the inter-class separability and intra-class compactness. In an embodiment, such loss functions may also be used in distributed communications where the feature extraction unit (e.g., feature extraction unit 110) and the classification unit (e.g., classification unit 120) are physically disjoint.

In an embodiment, the neural network 100 is configured to perform a training phase, during which a loss function [symbol] _{CET} as follows is minimized:

$${ℒ}_{CET} ( {q}_{i} , {y}_{i} ) = - log \frac{{e}^{scos ( {θ}_{{q}_{i} , {w}_{{y}_{i}}} + m )}}{{e}^{scos ( {θ}_{{q}_{i} , {w}_{{y}_{i}}} + m )} + {\sum }_{j \neq {y}_{i}} {e}^{scos ( {θ}_{{q}_{i} , {w}_{j}} )}} ; \qquad equation 2$$

In equation 2 above, qᵢ denotes a query vector of iteration i, y₁ denotes the output vector of iteration i. The hyperparameters s and m are used to guide the neural network for generating better quasi-orthogonal query vectors, and maximizing the inter-class separability and intra-class compactness. This is in part due to the additional angular margin introduced by the parameter m. Such loss functions are described, in further detail, with reference to ArcFace (Deng et. al, “Arcface: Additive angular margin loss for deep face recognition,” IEEE CVPR 2019).

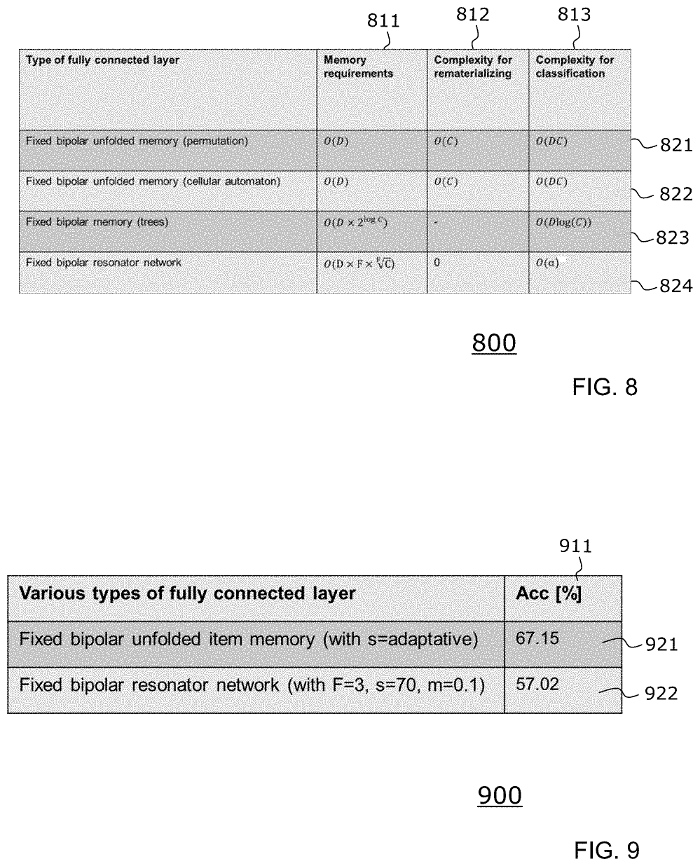

FIG. 8 illustrates a table, generally designated 800, listing the memory requirements, the complexity for rematerializing the fixed classification matrix, and the complexity to perform the classification in accordance with various embodiments of the present invention. As depicted in FIG. 8, column 811 lists the memory requirements for storing a fixed classification matrix, column 812 lists the computational complexity for rematerializing the fixed classification matrix, and column 813 lists the computational complexity for performing the classification. It should be noted that “O” denotes the order, “D” denotes the dimension of the query vector, and “C” denotes the number of classes.

Row 821 lists the respective requirements for the fixed classification matrix Win an unfolded item memory as described above with reference to FIGS. 2 and 3.

Row 822 lists the respective requirements for the fixed classification matrix W using D-dimensional cellular automaton 500 as described above with reference to FIG. 5.

Row 823 lists the respective requirements for the fixed classification matrix W using the search tree 400 (e.g., a binary search tree) as described above with reference to FIG. 4.

Row 824 lists the respective requirements for the fixed classification matrix W using a resonator network (e.g., resonator network 600) as the classification unit as explained with reference to FIG. 6.

FIG. 9 illustrates a table, generally designated 900, listing the classification accuracy in accordance with various embodiments of the present invention. As depicted in FIG. 9, column 911 the classification accuracy for respective embodiments of the present invention.

Row 921 lists the respective accuracy for the fixed classification matrix W stored in an unfolded item memory as described above with reference to FIGS. 2 and 3. For the training, the loss function according to equation 2 as described above was used. The hyperparameter s has been used in an adaptive manner to maximize the inter-class separability.

Row 922 lists the respective requirements for the fixed classification matrix W using a resonator network (e.g., resonator network 600) as the classification unit as explained with reference to FIG. 6. Here, the resonator network used comprised of F=3 codebooks. For the training, the loss function according to equation 2 as described above was used. The hyperparameter s was set to s=70 and the hyperparameter m was set to m=0.1. Doing so achieves a good trade-off between inter-class similarity and intra-class compactness, which ultimately yielded an optimal accuracy of the resonator network.

It should be appreciated and as demonstrated by FIG. 9, the fixed classification matrix stored in an unfolded item memory provides a higher classification accuracy than the resonator network. On the other hand, as explained above, the resonator network provides advantages in terms of classification speed.

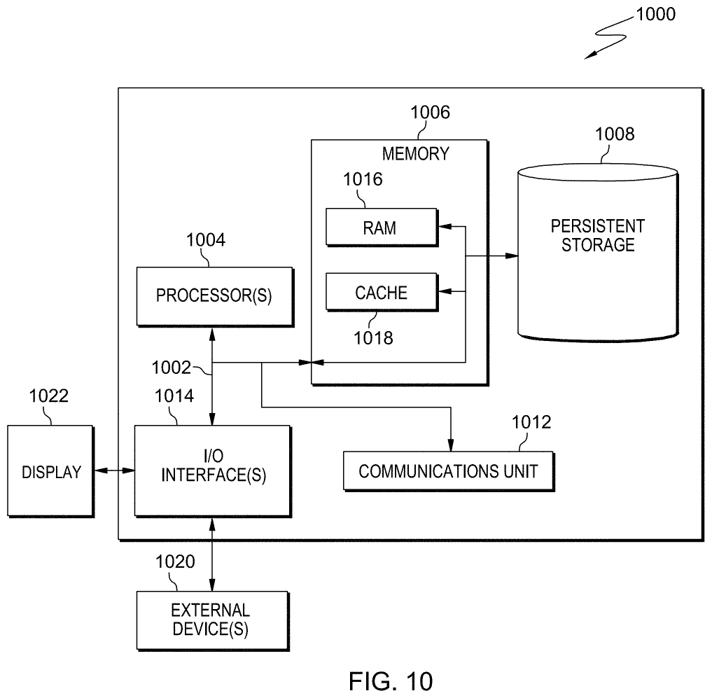

FIG. 10 is a block diagram depicting components of a computing device, generally designated 1000, suitable for practicing various embodiments of the present invention. Computing device 1000 includes one or more processor(s) 1004 (including one or more computer processors), communications fabric 1002, memory 1006 including, RAM 1016 and cache 1018, persistent storage 1008, communications unit 1012, I/O interface(s) 1014, display 1022, and external device(s) 1020. It should be appreciated that FIG. 10 provides only an illustration of one embodiment and does not imply any limitations with regard to the environments in which different embodiments may be implemented. Many modifications to the depicted environment may be made.

As depicted, computing device 1000 operates over communications fabric 1002, which provides communications between computer processor(s) 1004, memory 1006, persistent storage 1008, communications unit 1012, and input/output (I/O) interface(s) 1014. Communications fabric 1002 can be implemented with any architecture suitable for passing data or control information between processor(s) 1004 (e.g., microprocessors, communications processors, and network processors), memory 1006, external device(s) 1020, and any other hardware components within a system. For example, communications fabric 1002 can be implemented with one or more buses.

Memory 1006 and persistent storage 1008 are computer readable storage media. In the depicted embodiment, memory 1006 includes random-access memory (RAM) 1016 and cache 1018. In general, memory 1006 can include any suitable volatile or non-volatile one or more computer readable storage media.

Program instructions used to practice various embodiments of the present invention can be stored in persistent storage 1008, or more generally, any computer readable storage media, for execution by one or more of the respective computer processor(s) 1004 via one or more memories of memory 1006. Persistent storage 1008 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 1008 may also be removable. For example, a removable hard drive may be used for persistent storage 1008. Other examples include optical and magnetic disks, thumb drives, and smart cards that are inserted into a drive for transfer onto another computer readable storage medium that is also part of persistent storage 1008.

Communications unit 1012, in these examples, provides for communications with other data processing systems or devices. In these examples, communications unit 1012 can include one or more network interface cards. Communications unit 1012 may provide communications through the use of either or both physical and wireless communications links. In the context of some embodiments of the present invention, the source of the various input data may be physically remote to computing device 1000 such that the input data may be received, and the output similarly transmitted via communications unit 1012.

I/O interface(s) 1014 allows for input and output of data with other devices that may operate in conjunction with computing device 1000. For example, I/O interface(s) 1014 may provide a connection to external device(s) 1020, which may be as a keyboard, keypad, a touch screen, or other suitable input devices. External device(s) 1020 can also include portable computer readable storage media, for example thumb drives, portable optical or magnetic disks, and memory cards. Software and data used to practice embodiments of the present invention can be stored on such portable computer readable storage media and may be loaded onto persistent storage 1008 via I/O interface(s) 1014. I/O interface(s) 1014 also can similarly connect to display 1022. Display 1022 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

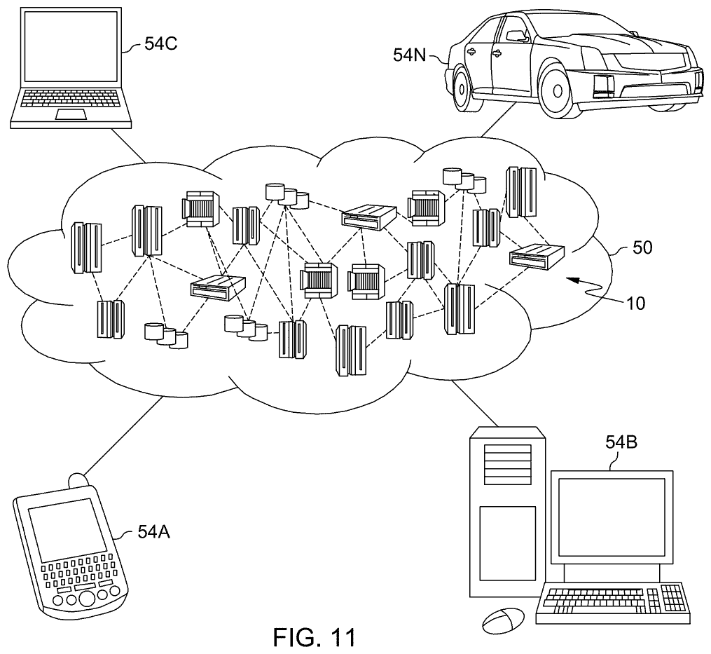

FIG. 11 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 11 are intended to be illustrative only and that computing nodes 10 and cloud computing environment 50 can communicate with any type of computerized device over any type of network and/or network addressable connection (e.g., using a web browser).

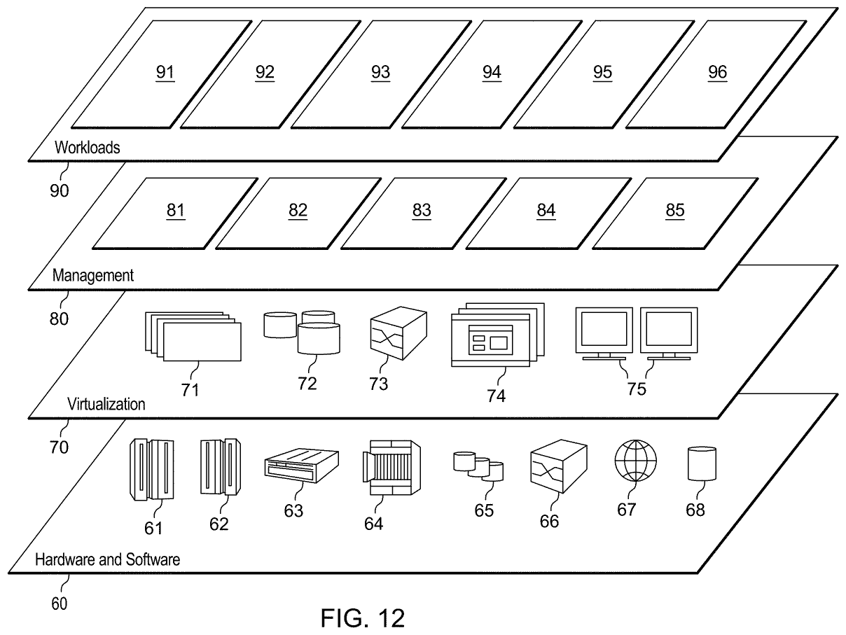

FIG. 12 is block diagram depicting a set of functional abstraction model layers provided by cloud computing environment 50 depicted in FIG. 11 in accordance with at least one embodiment of the present invention. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and classification using neural networks having a fixed classification matrix 96.

What is claimed is:

1. A computer-implemented method for performing a classification of an input signal utilizing a neural network, comprising:
computing, by a feature extraction unit of the neural network, a D-dimensional query vector, wherein D is an integer;
generating, by a classification unit of the neural network, a set of C fixed D-dimensional quasi-orthogonal bipolar vectors as a fixed classification matrix, wherein C is an integer corresponding to a number of classes of the classification unit; and
performing a classification of a query vector based, at least in part, on the fixed classification matrix.

2. The computer-implemented method of claim 1, further comprising:
computing, by the classification unit of the neural network, the set of C fixed D-dimensional quasi-orthogonal bipolar vectors from a D-dimensional seed vector, wherein the D-dimensional seed vector is a random bipolar seed vector.

3. The computer-implemented method of claim 2, further comprising:
computing, by the classification unit of the neural network, the set of C fixed D-dimensional quasi-orthogonal bipolar vectors by randomly permuting the D-dimensional seed vector.

4. The computer-implemented method of claim 2, further comprising:
storing the D-dimensional seed vector in an item memory;
performing a first similarity computation between the D-dimensional seed vector and the query vector to obtain a first class score;
iteratively performing a permutation step to compute a predefined permutation of the D-dimensional seed vector, wherein each permutation results in a respective permuted seed vector; and
performing, after each permutation step, a second similarity computation between the respective permuted seed vector and the query vector to obtain a second class score.

5. The computer-implemented method of claim 2, further comprising:
generating a D-dimensional cellular automaton;
initializing the D-dimensional cellular automaton based, at least in part, on the D-dimensional seed vector;
performing a first similarity computation between the D-dimensional seed vector and the query vector to obtain a first class score;
iteratively performing a permutation step to compute a predefined permutation of the D-dimensional seed vector, wherein each permutation results in a respective permuted seed vector, and further wherein the permutation step includes applying a transformation rule; and
performing, after each permutation step, a second similarity computation between the respective permuted seed vector and the query vector to obtain a second class score.

6. The computer-implemented method of claim 5, wherein the transformation rule is Rule 30.

7. The computer-implemented method of claim 1, further comprising:
generating a search tree, wherein the search tree includes C leaf nodes, and the C leaf nodes store the C fixed D-dimensional quasi-orthogonal bipolar vectors;
storing intermediate nodes and a root node by bundling the C fixed D-dimensional quasi-orthogonal bipolar vectors from nodes that are connected to the intermediate nodes or the root node; and
performing a similarity computation between the query vector and the C fixed D-dimensional quasi-orthogonal bipolar vectors by choosing a tree path having the highest similarity with the query vector.

8. The computer-implemented method of claim 7, wherein the search tree is at least one of a binary search tree and a ternary search tree.

9. The computer-implemented method of claim 1, further comprising:
performing a training phase with respect to the feature extraction unit, wherein the fixed classification matrix remains unchanged during the training phase.

10. The computer-implemented method of claim 1, further comprising:
performing a training phase with respect to the feature extraction unit, wherein the training phase is configured to minimize a loss function, the loss function being computed as follows:
$${ℒ}_{CET} ( {q}_{i} , {y}_{i} ) = - log \frac{{e}^{scos ( {θ}_{{q}_{i} , {w}_{{y}_{i}}} + m )}}{{e}^{scos ( {θ}_{{q}_{i} , {w}_{{y}_{i}}} + m )} + {\sum }_{j \neq {y}_{i}} {e}^{scos ( {θ}_{{q}_{i} , {w}_{j}} )}} ,$$
wherein qᵢ denotes a query vector of iteration i, yᵢ denotes the output vector of iteration i, and s and m are hyperparameters.

11. The computer-implemented method of claim 1, wherein the feature extraction unit of the neural network includes an activation layer, and further wherein the activation layer is configured to apply a tan h-function as an activation function.

12. The computer-implemented method of claim 11, wherein the activation layer is configured to apply a sharpened tan h-activation function.

13. The computer-implemented method of claim 1, wherein the feature extraction unit includes a pooling layer and an activation layer, and further wherein the pooling layer is prior to the activation layer.

14. The computer-implemented method of claim 13, wherein the pooling layer is an average pooling layer.

15. The computer-implemented method of claim 1, wherein the neural network further includes a vector interface between the feature extraction unit and the classification unit, and further wherein the vector interface is configured to bipolarize the query vector.

16. The computer-implemented method of claim 1, wherein the neural network includes a resonator network configured to provide a plurality of codebooks, and further wherein:
each codebook of the plurality of codebooks includes a set of codebook vectors;
a set of combinations of vector products of each codebook vector of the plurality of codebooks establishes the number of classes of the classification unit; and
performing, by the resonator network, a factorization of the query vector to each codebook vector of the plurality of codebooks to determine a corresponding class of the number of classes.

17. The computer-implemented method of claim 16, further comprising:
performing unbinding operations in parallel with respect to the plurality of codebooks.

18. A computer program product for performing a classification of an input signal by a neural network, the computer program product comprising one or more computer readable storage media and program instructions stored on the one or more computer readable storage media, the program instructions including instructions to:
compute, by a feature extraction unit of the neural network, a D-dimensional query vector, wherein D is an integer;
generate, by a classification unit of the neural network, a set of C fixed D-dimensional quasi-orthogonal bipolar vectors as a fixed classification matrix, wherein C is an integer corresponding to a number of classes of the classification unit; and
perform a classification of a query vector based, at least in part, on the fixed classification matrix.

19. A computer system for performing a classification of an input signal by a neural network, comprising:
one or more computer processors;
one or more computer readable storage media;
computer program instructions, the computer program instructions being stored on the one or more computer readable storage media for execution by the one or more computer processors; and
the computer program instructions including instructions to:
compute, by a feature extraction unit of the neural network, a D-dimensional query vector, wherein D is an integer;
generate, by a classification unit of the neural network, a set of C fixed D-dimensional quasi-orthogonal bipolar vectors as a fixed classification matrix, wherein C is an integer corresponding to a number of classes of the classification unit; and
perform a classification of a query vector based, at least in part, on the fixed classification matrix.

20. The computer system of claim 19, further comprising instructions to:
compute, by the classification unit of the neural network, the set of C fixed D-dimensional quasi-orthogonal bipolar vectors from a D-dimensional seed vector, wherein the D-dimensional seed vector is a random bipolar seed vector.
